(19) United States
(12) Patent Application Publication
(10) Pub. No.: US 2013/0037005 A1
(43) Pub. Date: Feb. 14, 2013

(54) INTERNAL COMBUSTION ENGINE HAIVNG CYLINDER DEACTIVATION

(71) Applicants: Bernhard Graf, Graz (AT); Paul Kapus, Judendorf (AT)

(72) Inventors: Bernhard Graf, Graz (AT); Paul Kapus, Judendorf (AT)

(73) Assignee: AVL LIST GMBH

(21) Appl. No.: 13/575,552

(22) PCT Filed: Jan. 18, 2011
(86) PCT No.: PCT/EP2011/050591

§ 371 Date: Oct. 11, 2012

(30) Foreign Application Priority Data
Feb. 4, 2010 (AT) A 156/2010

(51) Int. Cl. F02D 7/00

(52) U.S. Cl. 123/481

(57) ABSTRACT

An internal combustion engine (1) having at least two cylinders (4) or at least two groups (2, 3) of cylinders (4), of which at least one is electronically deactivatable, has at least one inlet strand (5, 6) and at least one outlet strand (7, 8). In order to improve the quality of the operating noise in the interior of a passenger cell, at least one inlet strand (5, 6) of at least one deactivated cylinder (4) can be acoustically connected via at least one sound conducting apparatus (21, 22) to an inner chamber (20) of a vehicle (19).

The invention relates to an internal combustion engine with at least two cylinders or at least two groups of cylinders, of which at least one can be deactivated electronically, comprising at least one inlet strand and at least one outlet strand. The invention further relates to a method for operating an internal combustion engine with at least two cylinders or at least two groups of cylinders, of which at least one is deactivated in one engine operating range.

EP 1 564 384 discloses a drive system with an internal combustion engine with several cylinders that can be deactivated. The internal combustion engine comprises a muffler with a valve which can be triggered by an electronic actuator, with the valve being switchable between an open position and a closed position. The open position corresponds to a V-8 mode and the closed position to a V-4 mode. Similar publications of an exhaust flap which influences the noise emission in the exhaust system of an internal combustion engine with cylinders that can be deactivated are known from the publications EP 1 561 917 A1 and DE 10 2004/046184 A1.

US 2003/066503 A further describes an internal combustion engine with two groups of cylinders which are respectively connected with the inlet strand. Every inlet strand comprises an inlet collector, with each inlet collector respectively being connected via a throttle valve with an inlet socket. In an operating range in which the cylinders of the second group are deactivated, air is supplied via the first throttle valve to the first inlet collector. If more power is required, the second cylinder bank can be activated, with air being supplied by the second throttle valve to the second inlet collector. The two inlet strands are arranged in such a way that there is a partial cancelling out of the intake noises in operation with all cylinders, so that the sound emission in operation with all cylinders corresponds approximately to the sound emission in operation with partly deactivated cylinders.

A method for reducing the engine friction loss in the part-load operation of an internal combustion engine with at least two groups of cylinders is known from AT 502 872 A1, with the cylinders of at least one group of cylinders being deactivated by deactivation of the injection in part-load operation and being operated with minimal friction losses, and with the cylinders of at least one second cylinder group being operated motively with optimal efficiency. The deactivation of the cylinders is controlled electronically.

In the cylinder deactivation in an internal combustion engine with six cylinders arranged in a V-like manner for example, the engine only runs with three cylinders in the part-load range during the activation of one cylinder bank for example. This leads to the consequence that as a result of the three missing ignitions (relating to 720° crankshaft rotation) the sound character of a three-cylinder engine will be produced. This is not desirable in high-class vehicles and is partly a criterion against the purchase of such a vehicle.

It is the object of the invention to avoid this disadvantage and to improve the noise in the interior space of the vehicle in an internal combustion engine of the kind mentioned above.

This is achieved in accordance with the invention such a way that at least one inlet strand of at least one deactivated cylinder can acoustically be connected via at least one sound-conducting device with an interior space of the vehicle.

The intake and exhaust valves of the deactivated cylinders are deactivated in mechanical cylinder deactivation. As a result, a change in the noise characteristics occurs both on the intake side and also on the exhaust side.

In the case of purely electronic cylinder deactivation without any closing of the valves, the intake noise characteristics remain virtually unchanged due to the virtually unchanged air mass which also applies in the case of deactivated cylinders, whereas the exhaust gas acoustics will change their characteristics due to the lack of ignitions on the deactivated cylinders. The present invention utilizes and amplifies this effect of constant intake acoustics.

It is preferably provided that the sound-conducting device comprises at least one acoustic switching device with which the inlet strand of the at least one deactivated cylinder can be connected acoustically with the interior space of the vehicle. The interior space of the vehicle can acoustically be separated from the inlet strand via the sound-conducting device once the at least one deactivated cylinder is reactivated again.

It is especially advantageous if the sound-conducting device originates from the region of an intake orifice of the inlet collector.

In the case of charged internal combustion engines, the sound-conducting device preferably originates from the high-pressure part of the inlet strand downstream of a compressor, preferably between a charge-air cooler and an inlet collector.

As a result of the described measures, the acoustic impression of an internal combustion engine working with all cylinders will be generated during the cylinder deactivation in the interior space of the vehicle. In order to achieve this effect, the contribution of the exhaust noise in the interior space of the vehicle is kept as low as possible by using both exhaust muffler volumes. Furthermore, the exhaust orifice noise can be dampened by throttling. In this process, a portion of the free cross-section of the exhaust system of one or both groups of cylinders will be blocked. As a result of the smaller cross-section which is designed for full-load throughput, the orifice noise will decrease. The exhaust muffler volumes can be switched by means of an exhaust flap. In addition, the pressure pulses in the inlet strand are used to a higher extent by means of the sound-conducting device for generating the interior sound. This is possible because the pressure pulses on the inlet side are influenced to an only very low extent by the electronically controlled cylinder deactivation. Air is also penetrated in the deactivated cylinder bank. The inlet sound is guided into the region of the splashboard or into the region of the interior space of the vehicle by using the sound-conducting device, and is optionally even amplified in certain frequency ranges.

The sound-conducting device can be formed by a soundpipe which ends in the region of the splashboard of the vehicle or is acoustically connected via a membrane with the interior space of the vehicle.

The invention will be explained below in closer detail by reference to the schematic drawings, wherein:

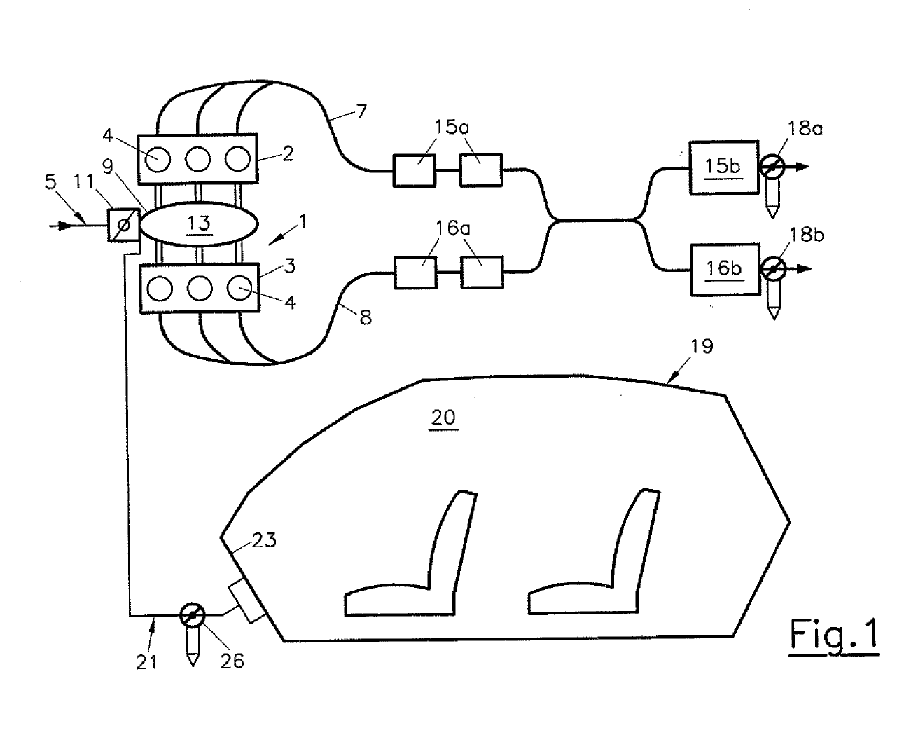

FIG. 1 shows an internal combustion engine in accordance with the invention in a first embodiment;

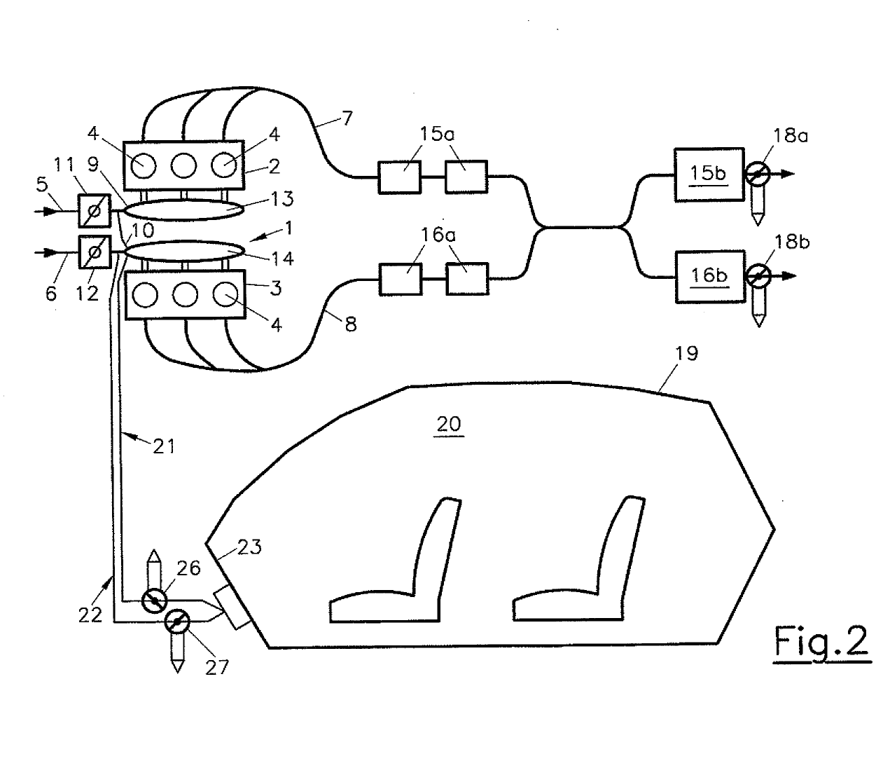

FIG. 2 shows an internal combustion engine in accordance with the invention in a second embodiment;

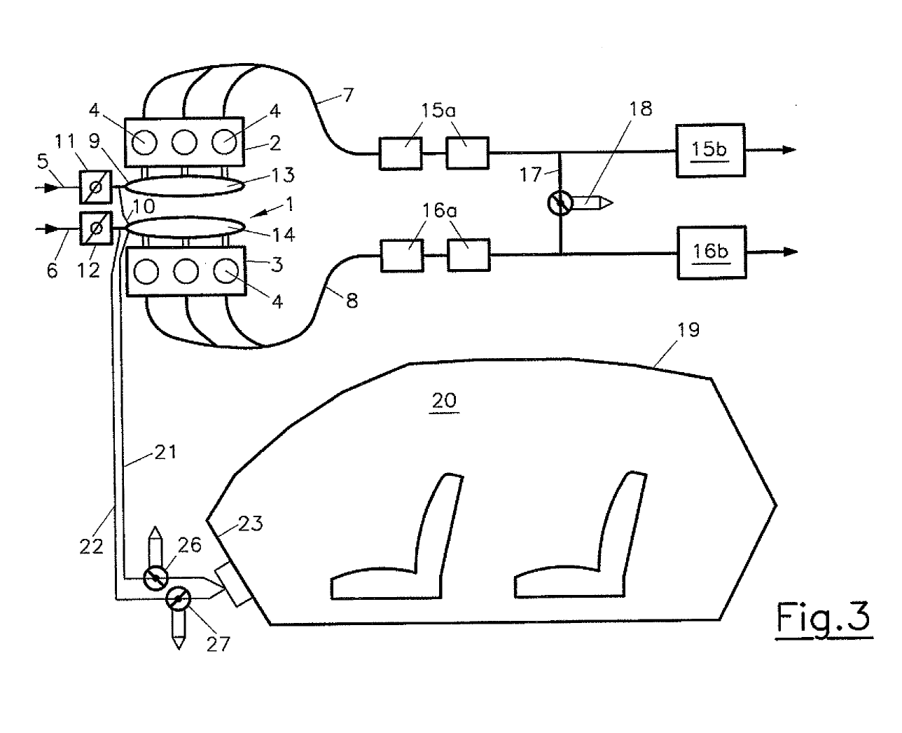

FIG. 3 shows an internal combustion engine in accordance with the invention in a third embodiment;

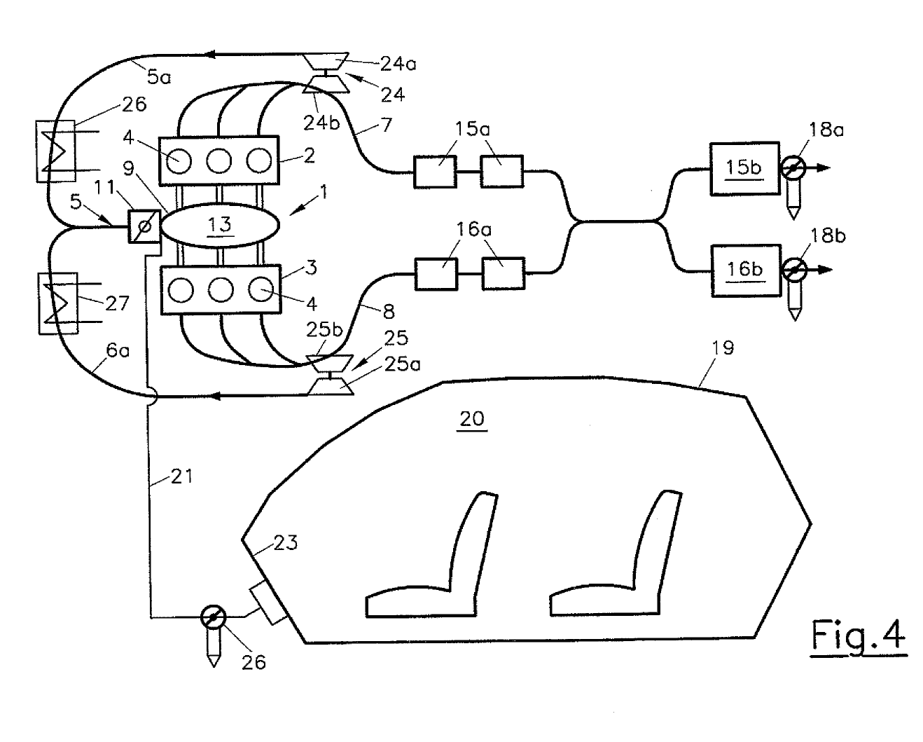

FIG. 4 shows an internal combustion engine in accordance with the invention in a fourth embodiment;

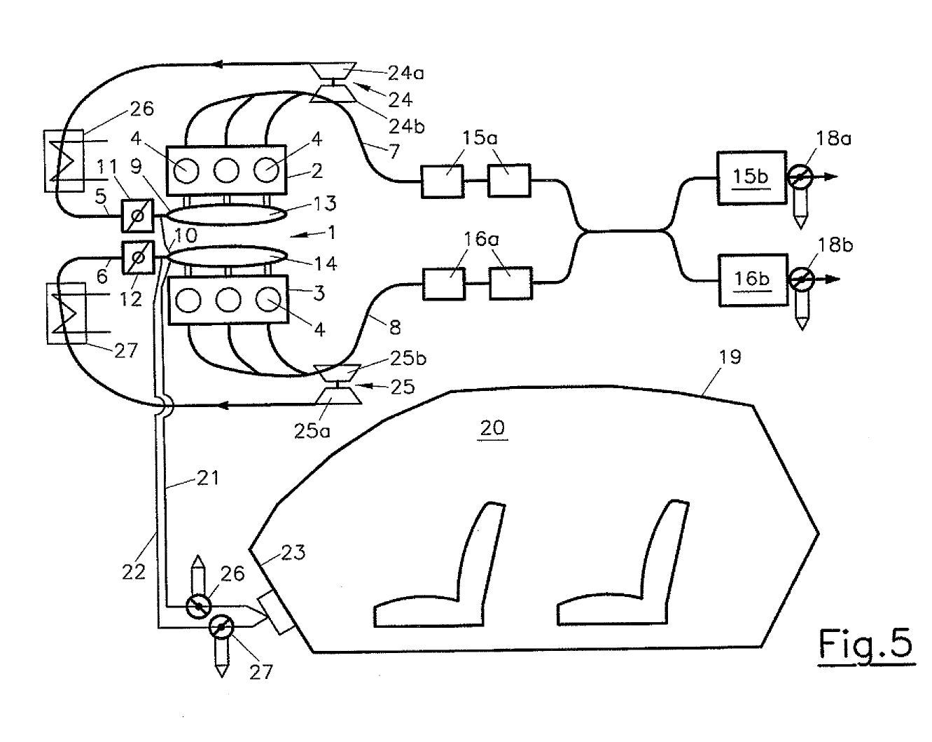

FIG. 5 shows an internal combustion engine in accordance with the invention in a fifth embodiment;

Parts with the same function are provided in the embodiment with the same reference numerals.

The drawings schematically show an internal combustion engine 1 with six cylinders 4 which are arranged in two groups 2, 3, with each of the groups 2, 3 being connected with an outlet strand 7, 8. At least one exhaust gas after-treatment device 15a, 16a and at least one exhaust muffler 15b, 16b is arranged in each outlet strand 7, 8.

FIG. 1 and FIG. 4 show embodiments in which the groups 2, 3 of cylinders 4 are connected with a single inlet collector 13 of an inlet strand 5.

Conversely, in the embodiments as shown in FIG. 2, FIG. 3 and FIG. 5 each group 2, 3 of cylinders 4 is respectively connected with one inlet collector 13, 14 of a separate inlet strand 5, 6.

In order to improve the sound in the interior space of the vehicle, at least one inlet strand 5, 6 is acoustically connected with the interior space 20 of the vehicle 19 via at least one sound-conducting device 21, 22 (e.g. a soundpipe), with the sound-conducting device 21, 22 ending in the region of the splashboard 23 of the vehicle 19 in the embodiments. The sound-conducting device 21, 22 may comprise an acoustic switching device 26, 27, with which the acoustic connection between the inlet strand 5, 6 and the interior space 20 of the vehicle 19 can selectively be produced under partly deactivated cylinders 4, or can selectively be separated when all cylinders 4 are activated.

The sound-conducting device 21, 22 advantageously originates from a region of the inlet strand 5, 6 between the throttle valve 11, 12 and the inlet collector 13, 14, especially advantageously from the region of the intake orifice 9, 10 of the inlet collector 13, 14.

During cylinder deactivation, the acoustic impression of an internal combustion engine 1 operating with all cylinders 4 is generated by the sound-conducting device 21, 22 in the interior space 20 of the vehicle 19. In order to achieve this, the contribution of the exhaust noise in the interior space 20 will be kept as low as possible by using the volumes of the two exhaust mufflers 15, 16. The exhaust mufflers 15, 16 can be switched into a connecting line 17 as shown in FIG. 3 by means of a switching member 18 which is formed by an exhaust flap for example. In the case of outlet strands 7, 8 which join and separate again in sections, throttling members 18a, 18b can also be arranged downstream of the mufflers. The exhaust orifice noise can therefore be dampened by throttling. A portion of the free cross-section of one or both outlet strands 7, 8 will be blocked. The exhaust orifice noise will decrease by the smaller cross-section (which is configured for full load). In addition, the pressure pulses in the inlet strand 5, 6 are used to a higher extent by means of the sound-conducting device 21, 22 for generating the interior sound. This is possible because the pressure pulses on the inlet side are influenced to an only very low extent by the electronically controlled cylinder deactivation. Air is also penetrated in the deactivated group 3 of cylinders 4. The inlet sound is guided into the region of the splashboard 23 or into the region of the interior space 20 of the vehicle 19 by using the sound-conducting device 21, 22 and optionally even amplified in certain frequency. ranges.

FIG. 4 and FIG. 5 show embodiments of the invention with one respective charged internal combustion engine 1, with a compressor 24a, 25a of an exhaust gas turbocharger 24, 25 being arranged in each inlet strand 5a, 6a or 5, 6. The exhaust turbines of the exhaust gas turbocharger 24, 25 are provided with reference numerals 24b and 25b. When the internal combustion engine 1 is charged, the sound-conducting device 21, 22 originates from the high-pressure part of the inlet strand 5, 6 between the compressor 24, 25 and the inlet collector 13, 14. As a result, the pressure pulses in the inlet strand 5, 6 can be utilized optimally for generating an appealing sound in the interior space 20 of the vehicle 19 even when the internal combustion engine 1 is charged. In FIG. 4, the two inlet strands 5a, 6a join downstream of charge-air coolers 26, 27 into a single inlet strand 5, which leads into an inlet collector 13 which is common for both groups 2, 3 of cylinders 4. A sound-conducting device 21 which leads to the interior space 20 of the vehicle 19 originates from the intake orifice 9 of the inlet collector 13. In the embodiment according to FIG. 5 on the other hand, the two inlet strands 5, 6 are separated completely from one another even downstream of the charge-air cooler 26, 27, with a sound-conducting device 21, 22 originating from each inlet strand 5, 6.

1. An internal combustion engine (1) with at least two cylinders (4) or at least two groups (2, 3) of cylinders (4), of which at least one can be deactivated electronically, comprising at least one inlet strand (5, 6) and at least one outlet strand (7, 8), wherein at least one inlet strand (5, 6) of at least one deactivated cylinder (4) can acoustically be connected via at least one sound-conducting device (21, 22) with an interior space (20) of a vehicle (19).

2. The internal combustion engine (1) according to claim 1, wherein the sound-conducting device (21, 22) originates from the region of an intake orifice (9, 10) of the inlet collector (13, 14).

3. The internal combustion engine (1) according to claim 1, wherein the sound-conducting device (21, 22) originates from a region between a throttle valve (11, 12) and an inlet collector (13, 14) of the inlet strand (5, 6).

4. The internal combustion engine (1) according to claim 1, wherein the sound-conducting device (21, 22) originates from a high-pressure part of the inlet strand (5, 6) arranged downstream of a compressor (24a, 25a), preferably between a charge-air cooler (26, 27) and an inlet collector (13, 14) arranged in the inlet strand (5, 6).

5. The internal combustion engine (1) according to claim 1, wherein the sound-conducting device (21, 22) opens into the interior space (20) of the vehicle (19).

6. The internal combustion engine (1) according to claim 1, wherein the sound-conducting device (21, 22) ends in the region of a wall adjoining the interior space (20) of the vehicle (19), preferably in the region of a splashboard (23).

7. The internal combustion engine (1) according to claim 1, wherein the sound-conducting device (21, 22) is formed by a soundpipe.

8. The internal combustion engine (1) according to claim 1, wherein at least one cylinder (4) of the internal combustion engine (1) can be deactivated without any deactivation of the inlet and/or exhaust valves.

9. The internal combustion engine (1) according to claim 1, comprising at least two outlet strands (7, 8), wherein at least two exhaust strands (7, 8) can be flow-connected with each other via at least one switching member (18).

10. The internal combustion engine (1) according to claim 1, comprising at least two outlet strands (7, 8), wherein at least one outlet strand (7, 8) comprises at least one throttling member (18a, 18b) for reducing the exhaust cross-section.

11. The internal combustion engine (1) according to claim 1, wherein the sound-conducting device (21, 22) comprises an acoustic switching device (26, 27).

12. A method for operating an internal combustion engine (1) with at least two cylinders (4) or at least two groups (2, 3) of cylinders (4), of which at least one will be deactivated in at least one engine operating range, wherein at least during the cylinder deactivation at least one inlet strand (5, 6) of at least one deactivated cylinder (4) will be acoustically connected via a sound-conducting device (21, 22) with an interior space (20) of a vehicle (19).

13. The method according to claim 12, wherein during the cylinder deactivation at least the inlet valves of a deactivated cylinder (4) are continued to be actuated in the manner of engine operation.

14. The method according to claim 12, wherein during the cylinder deactivation at least the exhaust valves of a deactivated cylinder (4) are continued to be actuated in the manner of engine operation.

15. The method according to claim 13, wherein the interior space (20) of the vehicle (19) is acoustically separated from the inlet strand (5, 6) via the sound-conducting device (21, 22) once the at least one deactivated cylinder (4) is reactivated again.

16. The method according to claim 14, with the exhaust gas of at least two cylinders (4) being emitted via at least two separate outlet strands (7, 8), wherein during the cylinder deactivation the outlet strands (7, 8) are flow-connected with each other via at least one switching member (18).

17. The method according to claim 15, with the exhaust gas of at least two cylinders (4) being emitted via at least two separate outlet strands (7, 8), wherein during the cylinder deactivation the flow in at least one outlet strand (7, 8) will. be throttled via at least one throttling member (18a, 18b).
